(19) United States
(12) Patent Application Publication
(10) Pub. No.: US 2012/0145025 A1
(43) Pub. Date: Jun. 14, 2012

(54) METHOD FOR OPERATING A PRINTING PROCESS

(75) Inventor: Roland Grunder, Vordemwald (CH)

(73) Assignee: Mueller Martini Holding AG, Hergiswil (CH)

(21) Appl. No.: 13/324,377

(22) Filed: Dec. 13, 2011

(30) Foreign Application Priority Data
Dec. 13, 2010 (CH) 02073/10

(51) Int. Cl. B41F 33/00

(52) U.S. Cl. 101/483

(57) ABSTRACT

A method for operating a printing process for production of printed products includes integrating at a suitable location in the printing process at least one processing station for realizing a finishing process that is directed toward a specific location on the printed product. The processing station, or the finishing process realized with the processing station, is activated or deactivated according to a product-related sequence.

### CROSS-REFERENCE TO RELATED APPLICATION

This application claims the priority of the Swiss Patent Application No. 02073/10, filed on Dec. 13, 2010, the subject matter of which is incorporated herein by reference.

### BACKGROUND OF THE INVENTION

The present invention relates to a method for operating a printing process for the production of printed products.

### SUMMARY OF THE INVENTION

It is an object of the present invention to provide intermediary, so-called “inline” installed finishing units for a digital printing press which produces multipage printed products without a fixed print form. These finishing units form integral components of the printing process and do not in any way restrict or hinder the realizing of the printing process.

It is a further object of the present invention is to sequentially print multipage printed products, such as books, magazines, catalogs and the like, and to execute the planned finishing processes independent of the processing sequence and/or the time and/or the cycle during the course of the printing process.

The above and other objects are accomplished according to the invention by the provision of a method for operating a printing process for production of printed products which, in one embodiment, comprises: integrating at a suitable location in the printing process at least one processing station for realizing a finishing process that is directed toward a specific location on the printed product; and activating or deactivating, the processing station, or the finishing process realized with the processing station as a function of a product-related sequence.

The activation and deactivation of the processing station, or the finishing process realized with the processing station as a function of a product-related sequence, means the finishing process is activated only if the section on the printed product, which is to be treated and/or finished, moves past the corresponding location.

According to the invention, the finishing process is handled such that a distinction is made between intervals which are cycle-compatible and those which are not cycle-compatible.

In the first case (cycle-compatible), it is obvious that no special precautions need to be taken since the respective application runs time-synchronized and/or time-coherent within the time interval available for the printing process.

However, the problem is different if the finishing process needs more time for technical reasons as compared to the printing sequence, for example if a complete printed product section is to be finished integrally.

For those cases, the invention proposes a print-specific measure as a precaution, consisting of depositing blank pages in the upstream printing process which then meet the requirement of helping to operatively support the start and end of the application, so that the printed product section to be finished can be detected integrally. Printed product sections of this type, meaning the blank sheets, which help to “jointly support” are then removed later on. As a result, it is ensured that these printed product sections which are not synchronized in time with the printing operation can be finished completely and with the necessary quality.

According to an embodiment of the invention, means can furthermore be provided which are arranged stationary, relative to the printed product line, or which can be pivoted in or advanced toward the web, relative to the movement direction of the printed product web, and are immediately operational when the respective printed product section starts moving through the finishing station. Seen this way, these means are the actual operative elements used for the “joint support” in the finishing process. The aforementioned means thus will normally have a shape that meets the function of the blank sheets, in the fictional sense, by maintaining a clearance zone which corresponds to the surface of the printed product section to be finished.

Regardless of whether the above-described precautions or means are used, the advantages of the invention can be seen in that the dynamic of the printing process is not stressed by any type of interferences. All finishing processes can be realized within the sequence of a digital printing process.

### BRIEF DESCRIPTION OF THE DRAWINGS

The above and other features and advantages of the invention will be further understood from the following detailed description with reference to the accompanying drawings. All elements not required for the immediate understanding of the invention have been omitted herein. The same elements in the individual Figures are given the same reference numbers, wherein:

FIG. 1 shows a side view of a system with integrated finishing stations for producing a finished digitized printed product according to the invention;

FIG. 2 shows a plan view of the integrated system according to FIG. 1; and

FIG. 3 shows an alternative portion of the system according to FIG. 1.

### DETAILED DESCRIPTION

The term digital printing is understood to refer to a printing technology for which the print image is transferred directly from a computer to a printing press, without the use of a static print form. In contrast to the offset printing process, for example, no fixed print form is therefore needed and each sheet can per se be printed differently. Seen this way, digital printings have a high universality and an extremely high acceptance under the aspect of individual printing.

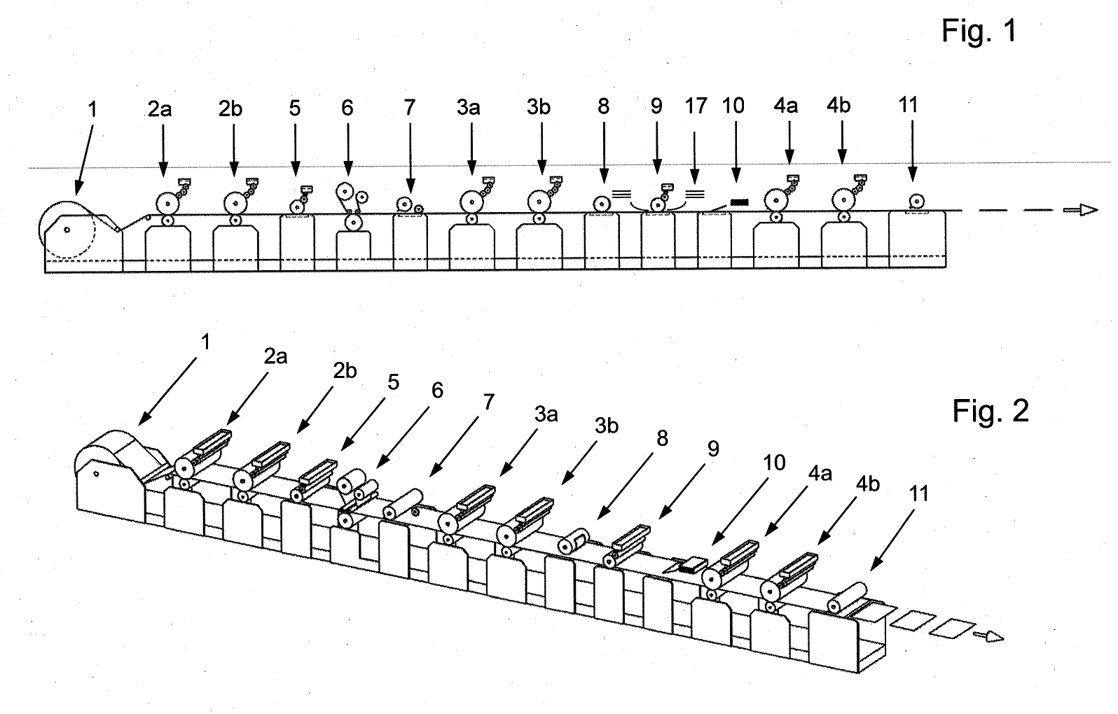

FIG. 1 shows an example of an integrated system for producing a finished, digitized printed product. The digital printing process is supplemented with the aid of a series of finishing units which are integrated as system components into the operational sequence for the digital printing process. This integration of the operating finishing units, however, should not be understood to mean that a fixed integration is desired or must exist. Rather, the respective finishing units form individual, flexible stations which can be added or removed, case by case, or can be switched on or switched off and can be replaced with different ones. The system therefore must logistically be configured such that the planned job can be realized easily. FIGS. 1 and 2 per se show an extensive path along which the printed product moves and which can be supplemented at any time, as needed, with additional finishing stations.

The starting point is an unprinted roll of paper 1, which ensures the continuous feeding of basic material for the printing process. Directly downstream thereof follow the stations which realize the digital printing operation. The number of digital printing units 2a, 2b is not restricted to the two for the printing steps shown herein. These units also do not have to realize the same operating functions, meaning the operation and the features of the individual printing units are adapted to the production of the respective printed product.

As shown by the sequence of processing steps for the system shown herein, additional digital printing units 4a, 4b are provided at the end of the path through which the web moves, wherein these units either end or supplement the printing process.

In between, the system is expanded extensively with a series of finishing stations realizing the multiple operations for finishing the printed product. It is clear that the finishing stations shown herein are not conclusive with respect to number, design, operation, process configuration and the like.

FIG. 1 is only intended to show various options for the system per se. The finishing units shown individually herein are those units which play a role in the production of present-day printed products, meaning products regularly in demand in the marketplace. A further station 5, for example, may be arranged downstream of the first digital printing units 2a, 2b and may be used for introducing special colors, varnishes or for applying adhesive. This may be followed by a station 6 for labeling and/or lamination. The product then may move on to a further station 7 for lateral or longitudinal perforation of the printed product. Additional printing units 3a, 3b can then be added for the further printing of the printed product, meaning at regular intervals and in dependence on the previous finishing steps. As a result, several finishing stations arranged successively can also form a step-by-step process.

The purpose of the additional stations that follow ultimately is to complete the printed products with additional features by moving them through, for example, a stamping/embossing station 8, as well as an additional printing station 9 for applying special colors, varnishes, adhesives. This may be followed by a qualitative expansion of the system where a supplement feeder 10 may be provided which can be used to supply the printed product with different, personalized supplements. The printed products may be then provided with a final printing, they are cut 11, and are then combined to form partial book blocks or complete book blocks.

With this representation of the various options realized with the finishing stations, it is clear that several applications can easily be realized time-neutral within the time interval made available for the printing process. Others cannot be realized time-neutral, for example if a complete printing section must be provided with a coating of varnish.

According to an embodiment of the invention, a precautionary measure may be taken of using previously deposited blank sheets for helping to jointly support the start and the end of the operation within the meaning of an intake and a discharge of, for example, the varnishing, wherein these blank sheets are later on removed from the process prior to the completion of a book block.

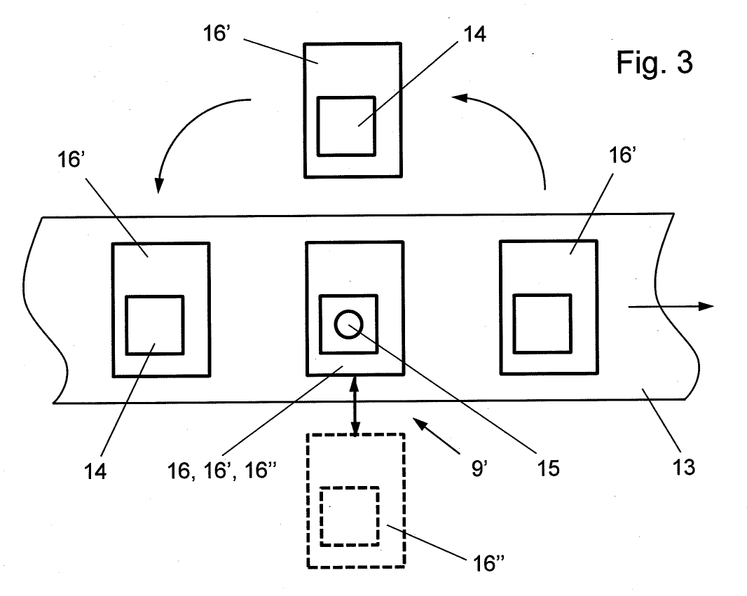

Another option that is shown in detail in FIG. 3 provides for means which are arranged, relative to the printed product web 13, in such a way that they become immediately active if the respective section of the printed product starts moving through the finishing station. A means of this type can advantageously be embodied in the shape of a relatively thin plate 16, 16′, 16″ provided with a window-like opening 14. This opening 14 corresponds to the surface of the printed product section to be finished, whereas the two brackets which are adjacent transverse to the printed product web 13 take over the function of the element which provides the required “joint support” for the finishing process. Such a plate 16, 16′, 16″ can without problem be arranged stationary, relative to the printed product web 13, and can be operatively connected to the location where the finishing process takes place. A plate of this type can also be pivoted-in or advanced temporarily toward the web 13. In contrast to FIG. 1 in FIG. 3 a processing unit 9′ is arranged, replacing the finishing station 9. The processing unit 9′ has a coating nozzle 15 being arranged above one of the plates 16, 16′ or 16″, which are supplied each with a window-like opening 14. From this coating nozzle 15 colors, varnishes or adhesives are coated for example on the delimited area of the printed product web 13 defined by the window-like opening 14. The plate 16 can be arranged stationary below the coating nozzle 15 for example. In an alternative case the plate 16′ is pivoted in or out, whereas moving along the printed product web 13 or remaining stationary below the coating nozzle 15. In contrast the plate 16″ is advanced toward the web, not moving along with the printed product web 13. In case of a change in the surfaces of the sections on the printed products to be finished, optional devices can be provided which can adjust the opening in the plate to match this change. The brackets in the region of the opening may be chamfered such that in the transition region leading toward the opening, the thickness tends toward zero.

Extensive finishing steps can also be implemented subsequently, within the predetermined cycle. In that case, the two above-described means can be omitted.

FIG. 2 shows the integrated system according to

FIG. 1 from a plan view. The individual printing units 2a, 2b; 3a, 3b; 4a, 4b remain unchanged, wherein the same is also true for the finishing stations 5-10.

It will be understood that the above description of the present invention is susceptible to various modifications, changes and adaptations, and the same are intended to be comprehended within the meaning and range of equivalents of the appended claims.

What is claimed:

1. A method for operating a printing process for production of printed products, comprising:
integrating at a suitable location in the printing process at least one processing station for realizing a finishing process that is directed toward a specific location on the printed product; and
activating or deactivating the processing station, or the finishing process realized with the processing station, according to a product-related sequence.

2. The method according to claim 1, including one of specifying, changing or adapting the sequence at a start of the printing process.

3. The method according to claim 1, including producing the printed products format dependent and with the aid of a digital printing process.

4. The method according to claim 1, further including jointly supporting a start and an end of the finishing process, relative to a printed product surface to be finished, for a finishing process which requires a longer application time, as compared to a time interval predetermined by the printing cycle.

5. The method according to claim 4, wherein the jointly supporting step includes pre-arranging a blank sheet adjacent to a printed product surface to be finished and removing the blank sheet during a following processing step.

6. The method according to claim 4, wherein the jointly supporting step includes providing a plate with a window opening that matches the section of the printed product to be finished.

7. The method according to claim 6, including operating the plate so that it is one of stationary, pivoted-in or advanced toward the web, relative to the movement direction of the printed product web.

8. The method according to claim 6, including adjusting the opening in the plate.

9. The method according to claim 6, including providing the plate with a chamfering in a region adjacent to the opening.

10. The method according to claim 1, including adding or removing the processing station sequentially for realizing the finishing process.

11. The method according to claim 1, including using the processing stations for at least one of the following applications in order to realize the finishing process on the printed product: varnishing; spot varnishing;
applying of special colors; stamping, perforating;
embossing; forming of windows; and gluing on of cards.

12. The method according to claim 1, including executing the printing process with the aid of a roll-fed digital printer.
